(19) United States
(12) Patent Application Publication
(10) Pub. No.: US 2013/0222318 A1
(43) Pub. Date: Aug. 29, 2013

(54) IMAGING SYSTEM CONSOLE

(71) Applicants: Shlomo Gotman, Haifa (IL); Guido Pardo Roques, Haifa (IL)

(72) Inventors: Shlomo Gotman, Haifa (IL); Guido Pardo Roques, Haifa (IL)

(73) Assignee: KONINKLIJKE PHILIPS ELECTRONICS N.V., EINDHOVEN (NL)

(21) Appl. No.: 13/881,160

(22) PCT Filed: Oct. 26, 2011
(86) PCT No.: PCT/IB11/54784

§ 371 Date: Apr. 24, 2013

Related U.S. Application Data
(60) Provisional application No. 61/407,170, filed on Oct. 27, 2010.

(51) Int. Cl. G06F 3/0488

(52) U.S. Cl. CPC G06F 3/0488
USPC 345/173

(57) ABSTRACT

A system (101) includes an imaging apparatus (100) configured for imaging a patient; and a console (114) for controlling the imaging apparatus. The console includes a processor and application memory encoded with computer readable instructions for visually presenting a touch screen interactive graphical user interface based console application for controlling the imaging apparatus for scanning the patient without an auxiliary input device. A method for controlling an imaging apparatus for scanning a patient includes employing a computer based operator console displaying a touch screen interactive graphical user interface to control imaging operations of the imaging apparatus for an imaging examination of the patient through only at least one of physical touch, gesture or voice.

The following generally relates to imaging systems and is described with application to computed tomography (CT) and particularly with a console for controlling the imaging system. The following is also amenable to other imaging modalities such as positron emission tomography (PET), single photon emission tomography (SPECT), magnetic resonance imaging (MRI), ultrasound (US) imaging, digital radiography, and/or other imaging modalities.

A computer tomography (CT) scanner includes an x-ray tube that emits radiation. A source collimator is disposed between the x-ray tube and an examination region and collimates the emitted radiation to produce a fan or cone shaped x-ray beam. The collimated beam traverses the examination region and a subject therein (which attenuates the beam as a function of the radiodensity of the object or subject) and illuminates a detector array disposed across the examination region from the x-ray tube. The detector produces projection data indicative of the detected radiation. A reconstructor reconstructs the projection data and generates image data indicative of the subject.

A general purpose computing system has been used the operating console for controlling the scanner. With conventional CT scanners, the operating console has been located in a control room, which is separate from the CT examination room, and the CT scanning procedure, for example, starting from patient selection/definition, to procedure planning, through scan activation and subsequent reviewing of the resulting images, is controlled from the room via the console using a traditional CRT or flat panel display, a mouse (trackball, or the like), and keyboard. Other equipment in the control room may include a Filmer, a microphone/speaker system for talking a patient in the examination room, and/or other equipment that might be used by the technician to facilitate performing a scan.

Unfortunately, such a console and such use thereof forces the operator to go back-and-forth between the examination room and a control room when setting up a patient to be scanned, which consumes times that could otherwise be spent with the patient and/or scanning other patients. In addition, the patient may move and no longer be located where the operator positioned the patient and believes the patient to be, which may affect the information represented in the resulting images and/or image quality. Moreover, the operator may be more susceptible to leaving out a step, which may lead to starting the study over again.

Aspects of the present application address the above-referenced matters and others.

According to one aspect, a system includes an imaging apparatus configured for imaging a patient; and a console for controlling the imaging apparatus. The console includes a processor and application memory encoded with computer readable instructions for visually presenting a touch screen interactive graphical user interface based console application for controlling the imaging apparatus for scanning the patient without an auxiliary input device.

According to another aspect, method for controlling an imaging apparatus for scanning a patient includes employing a computer based operator console displaying a touch screen interactive graphical user interface to control imaging operations of the imaging apparatus for an imaging examination of the patient through only at least one of physical touch, gesture or voice.

According to another aspect, a method includes performing an imaging examination of a patient with an imaging apparatus utilizing an in-room fully touch-screen interactive operator console to control the imaging apparatus.

The invention may take form in various components and arrangements of components, and in various steps and arrangements of steps. The drawings are only for purposes of illustrating the preferred embodiments and are not to be construed as limiting the invention.

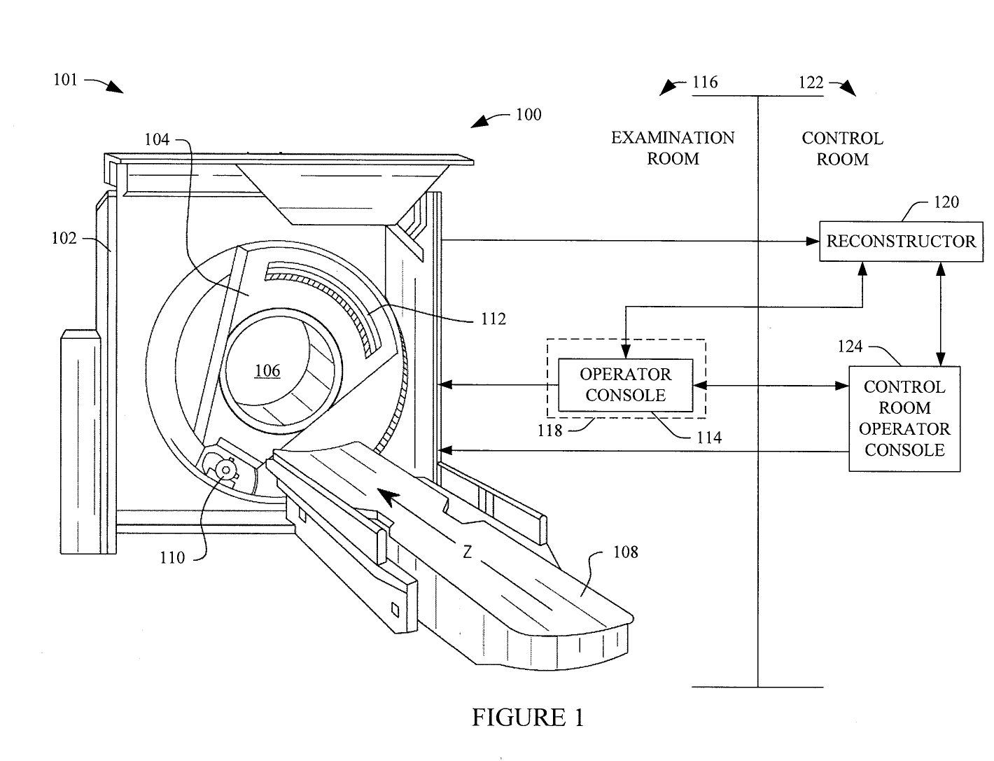

FIG. 1 illustrates an example imaging system in connection with an operator console for controlling the imaging system from the examination room.

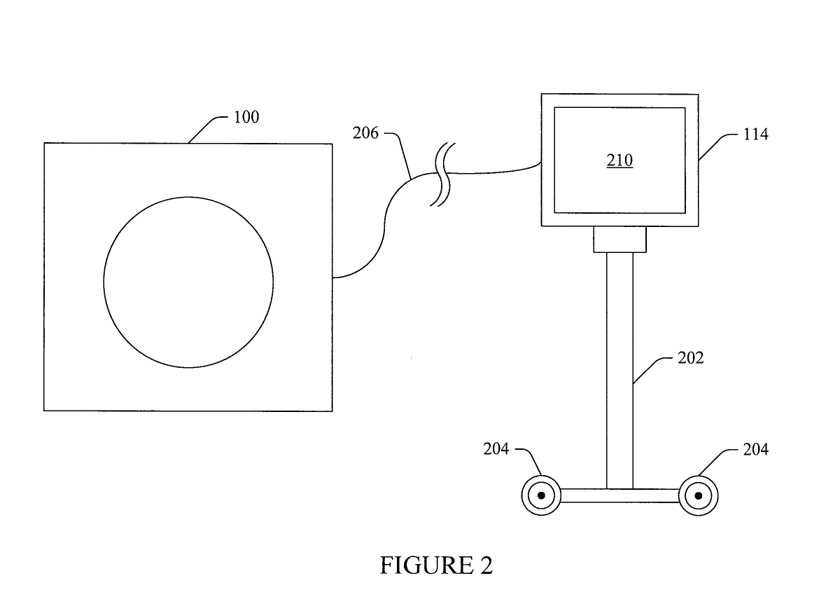

FIG. 2 illustrates an example operator console for controlling the imaging system from the examination room.

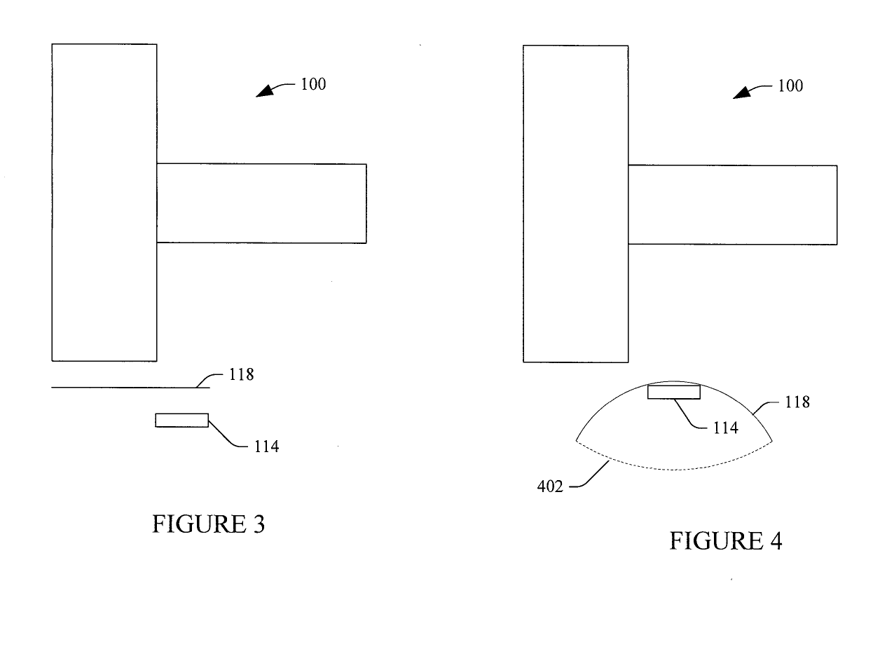

FIGS. 3 and 4 illustrate example radiation shields in connection with the imaging system and the operator console for controlling the imaging system from the examination room.

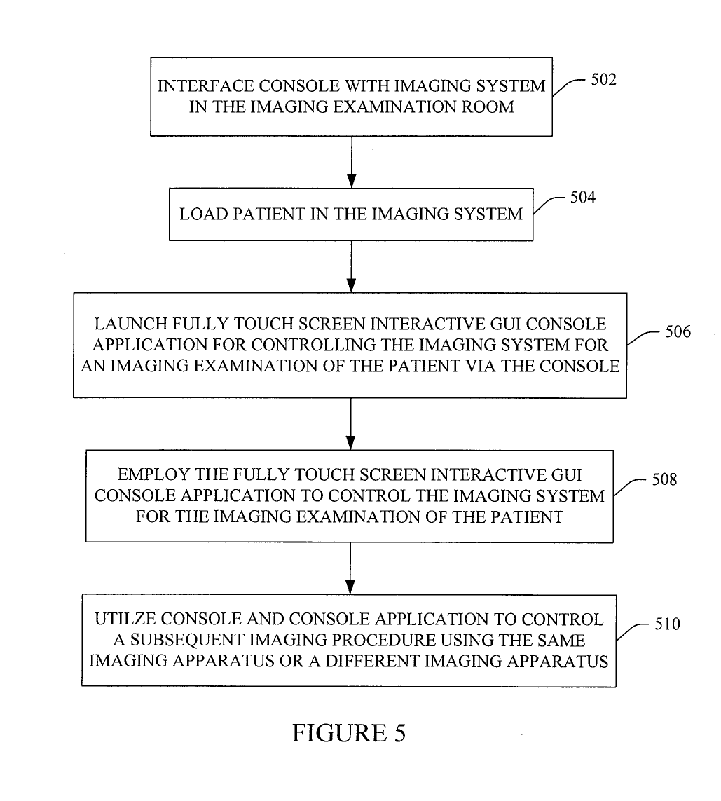

FIG. 5 illustrates an example method for controlling the imaging system from the examination room.

FIG. 1 illustrates a system 101 including an imaging apparatus 100 such as a computed tomography (CT) scanner. Other suitable imaging modalities include positron emission tomography (PET), single photon emission tomography (SPECT), magnetic resonance imaging (MRI), ultrasound (US) imaging, digital radiography, and/or other imaging modalities. However, for sake of brevity and explanatory purposes, the following is discussed in connection with a CT scanner.

The imaging apparatus 100 includes a stationary gantry 102 and a rotating gantry 104, which is rotatably supported by the stationary gantry 102. The rotating gantry 104 rotates around an examination region 106 about a longitudinal or z-axis. A patient support 108, such as a couch, supports a patient in the examination region 106 and is movable along the z-axis in coordination with the rotation of the rotating gantry 104 to facilitate helical, axial, or other desired scanning trajectories.

A radiation source 110, such as an x-ray tube, is supported by and rotates with the rotating gantry 104 around the examination region 106. The radiation source 110 emits generally fan, wedge, or cone shaped radiation that traverses the examination region 106. A radiation sensitive detector array 112 detects photons emitted by the radiation source 110 that traverse the examination region 106 and generates projection data indicative of the detected radiation.

The imaging system 101 further includes an operator console 114 includes one or more processors and computer readable storage medium (e.g., physical memory) encoded or embedded with computer readable instructions, which, when executed by the one or more processors cause the system to carry out various functions. The storage medium includes application memory for storing software applications such as a console application for controlling the apparatus 100 before, during and/or after performing an examination.

The operator console 114 can be located inside or outside of an examination room 116 for either in-(examination)room or external control. In one non-limiting embodiment, the console application, when executed by the processor(s), provides a touch screen interactive graphical user interface (GUI) for controlling the imaging apparatus 100 for performing an imaging examination of a patient using the imaging apparatus 100.

In one instance, the GUI is a fully touch screen interactive GUI can be used to fully control (e.g., for pre, scanning, and post scanning operations) the imaging apparatus 100 when performing an examination, without use of an auxiliary input device such as a pointing device (e.g., a mouse, a digital pen, a trackball, etc.), a keyboard, or the like. Of course, the operator console 114 can be used with auxiliary input devices and/or to only partially control the imaging apparatus 100 wherein another console such as the console 124 is also used to partially control the imaging apparatus 100.

When used in the examination room, a radiation shield 118 can be utilized to shield the operator console 114 and/or an operator utilizing the operator console 114 from radiation (e.g., scattered) in the examination room 116. The radiation shield 118 may completely surround the operator console 114 and the operator, as shown in the illustrated embodiment, or partially surround the operator console 114 and the operator, for example, providing a shield between the imaging apparatus 100 and the operator console 114 and the operator.

A reconstructor 120 reconstructs the projection data and generates volumetric image data indicative of the examination region 106. An image processing system can generate one or more images based on the reconstructed image data. Such images can be sent to a filmer, a viewing system, and/or other device. In the illustrated embodiment, the reconstructor 120 is located in a control room 122, which is separate from the examination room 116.

A general purpose computing system serves as a control room operator console 124 and is located in the control room. The control room operator console 124 includes an output device such as a display and an auxiliary input device such as a keyboard, mouse, and/or the like. Software resident on the operator room operator console 124 allows the operator to control the operation of the apparatus 100, for example, allowing the operator to initiate scanning, etc.

In the illustrated embodiment, either and/or both of the consoles 114 and 124 can be used to control the system. In another embodiment, the operator room operator console 124 is omitted.

FIG. 2 illustrates an example in which the operator console 114 is affixed to a moveable stand 202.

In this embodiment, the stand 202 has one or more rolling elements such as casters, balls, wheels 204 and is moveable, for example, within the examination room 116. In another embodiment, the stand 202 does not have wheels and rests on a surface such as the floor in the examination room, a table, etc. With both embodiments, the weight, shape, and size of the console 114 and stand 202 is such that a operator can readily roll and/or pick up and move the console 114 and stand 202 within the examination room 116. In one instance, the size of the console 114 is no larger than the display used in connection with the control room operator console 114.

In yet another embodiment, the stand 202 is fixedly mounted to the surface. In this instance, the console 114 can fixedly or removeably mount to the stand 202. Furthermore, the stand 202 may be configured to telescope or otherwise be positional in along a vertical axis from the floor. This allows the operator to lower or raise the vertical height of the console 114, relative to the floor, based on the height of the operator, whether the operator is sitting or standing, etc. The console 114 may also be mounted such that it can be tilted or pivoted back and forth on the stand 202 and/or rotate about the stand 202 by the operator.

The illustrated operator console 114 is in communication with the imaging apparatus 100 via a path 206, which, in this example, is for at least one of data, control signals, and power for powering the console 114. In another embodiment, the operator console 114 includes a wireless communications port (e.g., radio frequency (RF), optical, etc.) for communicating data and/or control signals.

Additionally or alternatively, the operator console 114 includes a power transformer for receiving power from the path 206 or through a power cable, which is configured for electrical communication with an AC receptacle, and for converting received power to energize the console 114. The power transformer may also be configured to receive and covert power from a battery pack to energize the console 114. In this instance, the console 114 may also include a battery charger for charging the battery pack, for example, when the power cable is plugged into the AC receptacle.

Such a console 114 allows for eliminating any need for the operator to move back-and-forth between the examination room and a control room, which may save time, allowing the operator to spend more time with the patient and/or scanning patients, and/or ensuring proper patient setup, and/or all steps of in the protocol are properly executed. Moreover, this allows the operator to be close to the patient, to be able to interact with him/her directly (e.g., visually, audibly, physically, etc.), and to provide fast assistance when needed (e.g., including reacting to change patient conditions quicker).

In an embodiment in which the console 114 includes a wireless communications port and a battery pack and the stand 202 has wheels 204, the console 114 can be moved from examination room to examination room (or other room) and communications software of the console 114 can be used to automatically or manually interface the console 114 with a particularly imaging system, such as the imaging system in the examination room in which the console is in, for control of the imaging system.

As briefly discussed above, in one embodiment, the console application includes an interactive touch screen based GUI 210 for fully controlling the imaging apparatus 100 to scan a patient without use of an auxiliary input device such as a mouse, a keyboard, or the like. (Although, such input devices can be used with the console 114. In addition, remote controls and other input devices can be used with the console 114.) Such an application allows the operator to perform various operations through physical contact and interaction with the GUI 210, for example, via screen touch or tap, drag and drop, touch flow, multi-touch and/or other physical interaction capabilities, and, optionally, gesture and/or voice recognition based capabilities.

For example, the operator can scroll through different display screens for pre-scanning (e.g., entering patient and/or imaging apparatus set up information), scanning (e.g., staring, pausing, terminating, etc. scanning), and/or post-scanning (e.g., viewing and evaluating projection and/or image data) operations merely be touching and/or swiping across the GUI 210.

In one instance, the operator can change the displayed screen simply by touching the corner of the GUI 210. In another instance, the operator can change a screen by touching the corner of the GUI 210 and moving or swiping their finger across the GUI 210 while maintaining physical contact with the console to an opposing corner of the screen. This may give the appearance of turning a page of paper. In this instance, the direction of the swipe may determine whether the screen advances to a next screen or returns a previous screen. In yet another instance, multiple taps or holding a physical touch for a pre-determined time duration changes the displayed screen.

In connection with a particular screen, an imaging related setting may be selected and/or adjusted through swiping, swirling, tapping and/or other physical interaction with the GUI 210. For example, such interaction can be utilized to select a patient from a list of patients, select an imaging protocol, select a tube voltage and/or current, (or adjust) one or more other settings, rotate, pan or re-size displayed information, initiate scanning, and/or otherwise interacting with the GUI 210.

A zoom operation may also be performed through physical contact or interaction with the screen. In one instance, zoom can be performed by placing two fingers on the GUI 210 and spreading the fingers to zoom in or closing the fingers to zoom out, or vice versa. In another instance, zoom is controlled by pressing on the GUI 210 and holding the press on the GUI 210. In this instance, the zoom is maintained as long as the press is being held or another operation is being performed. The GUI 210 reverts back to the un-zoomed state after a lapse of time in which an operation is not performed.

Such a feature may facilitate certain operations such as planning a scan in which the operator defines a start scan point and end scan point on a pilot scan. In this instance, the zoom feature may allow for a more precise and/or accurate identification of such points with an operator who is using a fingertip to indicate such points. With this embodiment, each touch of the GUI 210 may result in a predetermined step in zoom of then entire displayed information or a predetermined sub-set thereof.

Although some of the above examples include physical touch of the interactive GUI 210, in other embodiments the GUI 210 is configured to detect and/or sense non-physical touch based gestures and/or audible commands. In such embodiments, physical contact is not used to perform any of the above features as well as other features. However, in some of those embodiments, physical touch can additionally or alternatively be used. Such gesture and/or audible based embodiments may facilitate maintaining a contamination free environment.

The above examples are provided for explanatory purposes and are not limiting. As such, the various screens can be scrolled through and/or zoomed using other techniques. In addition, other capabilities such as pan, rotate, etc. may also be provide via the GUI 210.

In another embodiment, the stationary gantry 102 includes a mounting bracket for the console 114, and the console fixedly or removeably mounts to the mounting bracket. The mounting bracket alternatively is on a wall in the examination room 116, the radiation shield 118 and/or other surface.

In yet another instance, the console 114 can be utilized in the control room 122 via a docketing station or the like. In this instance, the console 114 can be moved from room to room and used independently in the examination room 116 or in conjunction with a keyboard, mouse, etc. in the control room 122.

In yet another instance, the console 114 is about the size as a standard cell phone or personal data assistant, and the clinician carries the console 114 around with them. In such an instance, the console 114 may include a cell phone like physical pointing instrument for alternative interaction with the console 114. In addition, such a console 114 may include a graphics controller for connecting the console 114 to a larger touch screen based monitor to the console 114 for a larger representation and easier interaction with the console application GUI 210.

FIG. 3 illustrates an example of the radiation shield 118 in connection with the imaging apparatus 100 and the console 114. In this example, the radiation shield 118 is positioned between then imaging apparatus 100 and the console 114. The shield 118 includes lead and may be semi-translucent, allowing the operator to see through the shield 118 and see the patient being scanned.

In another example, the radiation shield 118 is substantially opaque, and the operator steps behind the shield 118 to activate x-rays. With the example, the shield 118 may be configured to slide back and forth to move out of the way during pre-scan planning and setup and move between the imaging apparatus 100 and the console 114 during scanning Additionally or alternatively, the console 114 may be configured to slide back and forth for pre-scan planning and setup and scanning.

FIG. 4 illustrates another example of the radiation shield 118 in connection with the imaging apparatus 100 and the console 114. In this example, a back shield 402 shields the operator from scattered radiation, for example, from the walls. In one instance, the back shield 402 includes a lead curtain, which is normally open, providing free space for the operator to move between the console 114 and the operator. When the scan is about to start, the patient steps behind the shield 118, and the back shield 402 is closed, providing sufficient protection for the operator during the radiation.

In one instance, the back shield 402 can be opened and/or closed manually, for example, by the operator sliding the back shield 402 open or shut. In this instance, the back shield 402 may include a slide that slides along a rail on the floor, roller hangers that slides along a poll or the like extending across the top of the shield 118, etc. In another instance, the back shield 402 is configured to automatically move under control of the console 114, for example, through activation via the GUI 210. In yet another instance, a sensor near the console 114 identifies presence of the operator inside the protected area, and triggers the back shield 402 to automatically close.

In another embodiment, the shield 118 is affixed to the console 114 and the stand 202, and moves therewith. In this instance, the operator can roll the console 114, via the stand 202, about the room along with the radiation shield 118. This allows the operator to place the console 114 at a location based on the type of scan, the patient being scanned, etc.

FIG. 5 illustrates a method.

It is to be appreciated that the order of the below acts is not limiting. As such, one or more of the acts may occur in a different order. In addition, one or more of the acts may be omitted and/or one or more additional acts may be included.

At 502, the console 114 is brought into an examination room and interfaced with an imaging system therein. As described herein, in one instance this includes connecting the console 114 to the imaging system via one or more cables or wirelessly.

Alternatively, the console can be outside of the examination room.

At 504, a patient is loaded on the imaging system in the examination room. For example, the patient is placed on the subject support used to position the patient in the examination region of the imaging apparatus.

At 506, the console 114 is invoked to execute a console application, which includes a fully touch screen interactive GUI for controlling the system for scanning the patient. As described herein, such interaction includes, but is not limited to, at least one of touch, drag and drop, touch flow, multi-touch, etc. touch capabilities, and optionally gesture and/or voice recognition, capabilities, without an auxiliary input device such as a mouse, a keyboard, etc.

At 508, the GUI is employed for performing the examination, including, any pre-scanning, scanning, and/or post-scanning operations.

At 510, the console is utilized to perform a subsequent imaging examination for the same or another person. This includes utilizing the console in the same examination room with the same imaging apparatus or moving the console to another examination room and utilizing a different imaging apparatus, which may include the same imaging modality or a different imaging modality.

The above may be implemented by way of computer readable instructions, which when executed by a computer processor(s), cause the processor(s) to carry out the described acts. The acts need not be performed concurrently with data acquisition.

Although described in connection with a computed tomography (CT) scanner herein, the above can additionally or alternatively be employed in connection with other imaging modalities such as positron emission tomography (PET), single photon emission tomography (SPECT), magnetic resonance imaging (MRI), ultrasound (US) imaging, digital radiography, and/or other imaging modalities.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

1. A system, comprising
an imaging apparatus configured for imaging a patient; and
a console for controlling the imaging apparatus, wherein the console includes a processor and application memory encoded with computer readable instructions for visually presenting a touch screen interactive graphical user interface based console application for controlling the imaging apparatus for scanning the patient without a keyboard or pointing device.

2. The system of claim 1, wherein the touch screen interactive graphical user interface is configured for interaction via at least one of physical touch, drag and drop, touch flow, multi-touch, gesture recognition, or voice recognition.

3. The system of claim 2, wherein the touch screen interactive graphical user interface is fully touch screen interactive via only the least one of physical touch, drag and drop, touch flow, or multi-touch.

4. The system claim 1, wherein the interactive touch screen based graphical user interface is configured for one or more of pre-scanning, scanning, and post-scanning operation of the imaging apparatus.

5. The system of claim 1, wherein the imaging apparatus and the console are located in a same examination room in which the patient is imaged.

6. The system of claim 5 further comprising:
a radiation shield disposed between the imaging apparatus and the console.

7. The system of claim 1, further comprising:
a moveable stand, wherein the console is affixed to the moveable stand and moves with the moveable stand.

8. The system of claim 7, the moveable stand, comprising:
at least one wheel, wherein the stand moves via the at least one wheel.

9. The system of claim 7, the console, comprising:
a communication port configured for interfacing the console alternatively with one or a plurality of different imaging apparatuses, including the imaging apparatus.

10. The system of claim 7, wherein a size, shape and weight of the console and stand allow the stand and hence the console to be moved in and outside of the examination room.

11. The system claim 9, further comprising:
moving the console from examination room to examination room and interfacing the console for communicating only with the imaging system in the examination room in which the console is located.

12. The system of claim 7, wherein the console is fixedly attached to a mounting bracket in the examination room.

13. A method for controlling an imaging apparatus for scanning a patient, comprising:
employing a computer based operator console displaying a fully touch screen interactive graphical user interface to control imaging operations of the imaging apparatus for an imaging examination of the patient through only at least one of physical touch, gesture or voice.

14. The method of claim 13, wherein the physical touch includes at least one of tapping, multiple touches, or movement across the interactive touch screen graphical user interface.

15. The method of claim 13, further comprising:
entering pre-imaging examination patient and/or imaging apparatus set up information only through the at least one of touch, gesture or voice.

16. The method of claim 13, further comprising:
controlling the imaging system during the imaging examination only through the at least one of touch, gesture or voice.

17. The method of claim 13, further comprising:
viewing and evaluating image data from the imaging examination only through the at least one of touch, gesture or voice,

18. The method of claim 13, further comprising:
selectively employing the console alternatively with one of a plurality of imaging apparatuses configured to be controlled by the console.

19. The method of claim 13, wherein the computer based operator console is located in a same examination room as the imaging apparatus.

20. The method of claim 13, further comprising:
viewing a first screen of the graphical user interface;
physically touching a location of the graphical user interface; and
swiping across the graphical user interface while maintaining the physical touch with the graphical user interface to view a different screen of the graphical user interface.

21. The method of claim 13, further comprising:
viewing a first screen of the graphical user interface;
physically touching a location of the graphical user interface; and
zooming in on a predefined area around the touched location in response to holding the touch for a predetermined period of time.

22. The method of claim 21, further comprising;
returning to the pre-zoomed state in response to releasing the touch for another predetermined period of time.

23. The method of claim 21, further comprising:
identifying a start scan position via the graphical user interface while in a zoomed in state.

24. The method of claim 13, further comprising:
concurrently touching at least two locations of the graphical user interface;
moving the at least two locations apart or closer together to change a current zoom state of a predetermined area of the graphical user interface.

25. A method, comprising:
performing an imaging examination of a patient with an imaging apparatus utilizing an in-room fully touch-screen interactive operator console to control the imaging apparatus.
